(19) United States
(12) Patent Application Publication
(10) Pub. No.: US 2021/0129169 A1
(43) Pub. Date: May 6, 2021

(54) SPRINKLER PROTECTORS, AND ASSOCIATED SYSTEMS AND METHODS

(71) Applicants: Vernon K. Hyatt, Sandy, UT (US); Diane Hyatt, Sandy, UT (US)

(72) Inventors: Vernon K. Hyatt, Sandy, UT (US); Diane Hyatt, Sandy, UT (US)

(21) Appl. No.: 17/091,680

(22) Filed: Nov. 6, 2020

Related U.S. Application Data
(60) Provisional application No. 62/931,298, filed on Nov. 6, 2019.

(51) Int. Cl. B05B 15/16

(52) U.S. Cl. CPC B05B 15/16

(57) ABSTRACT

The present disclosure is related to sprinkler protectors. In at least one embodiment, a sprinkler protector may include a housing including a first end and a second, opposite end, the housing configured to receive a sprinkler head. The sprinkler protector may also include a removable lid for coupling to the first end of the housing. The lid may be configured to enable for access to the sprinkler head upon the lid being removed. Further, the lid including an opening to expose at least a portion of the sprinkler head while the lid is coupled to the first end of the housing. Moreover, the second, opposite end of the housing may include an opening configured such that the sprinkler head may be coupled to a sprinkler pipe.

### PRIORITY CLAIM

This application claims the benefit of the filing date of U.S. Provisional Patent Application Ser. No. 62/931,298, filed Nov. 6, 2019, for “Sprinkler Protectors, and Associated Systems and Methods.”

### TECHNICAL FIELD

This disclosure relates generally to sprinkler protectors and, more specifically, to sprinkler protector devices configured to be positioned within the ground and at least partially surround one or more sprinkler components.

### BACKGROUND

A sprinkler or irrigation system, which may include a number of sprinkler heads, is a system used to irrigate agricultural crops, lawns, landscapes, golf courses, and other areas. Sprinkler systems, which may include a network of pumps, valves, pipes, and/or sprinkler heads (sprinklers) may apply water in a controlled manner at one or more desired locations (e.g., of a lawn, field, or other landscape).

Frequently, components of a sprinkler system are damaged and/or broken due to various reasons (e.g., being stepped on, run over (e.g., by a lawn mower or a car), weather conditions, (e.g., freeze and crack), or other wear and tear). Repairing sprinkler components has proven to be a timely and frustrating process due to, for example, the time and effort required to dig up and access a broken component, and the time and effort to repair any damage done to the ground (e.g., lawn) after replacing or repairing the broken sprinkler component.

### BRIEF DESCRIPTION OF THE DRAWINGS

FIG. 1 is a perspective view of sprinkler protector including a lid, in accordance with various embodiments of the present disclosure.

FIG. 2 is a perspective view of a sprinkler protector, according to various embodiments of the present disclosure.

FIG. 3 is a side view of a sprinkler protector, according to various embodiments of the present disclosure.

FIG. 4 is a top view of a sprinkler protector, in accordance with various embodiments of the present disclosure.

FIG. 5 is a bottom view of a sprinkler protector, in accordance with various embodiments of the present disclosure.

FIG. 6 is a cut-out view of a sprinkler protector installed in the ground, according to various embodiments of the present disclosure.

FIG. 7 depicts a lid of a sprinkler protector including an opening, in accordance with various embodiments of the present disclosure.

FIG. 8 is another illustration of a sprinkler protector, in accordance with various embodiments of the present disclosure.

FIG. 9 is yet another illustration of a sprinkler protector, according to various embodiments of the present disclosure.

### DETAILED DESCRIPTION

Referring in general to the accompanying drawings, various embodiments of the present disclosure are illustrated to show a sprinkler protection device. Common elements of the illustrated embodiments are designated with like numerals. It should be understood that the figures presented are not meant to be illustrative of actual views of any particular portion of the actual device structure, but are merely schematic representations which are employed to more clearly and fully depict embodiments of the disclosure.

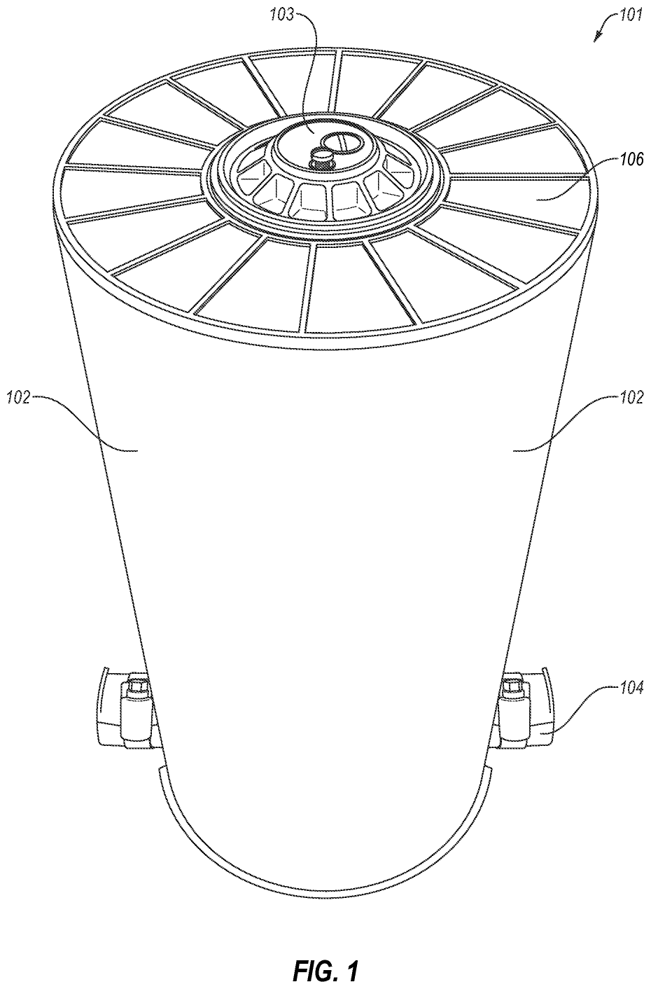

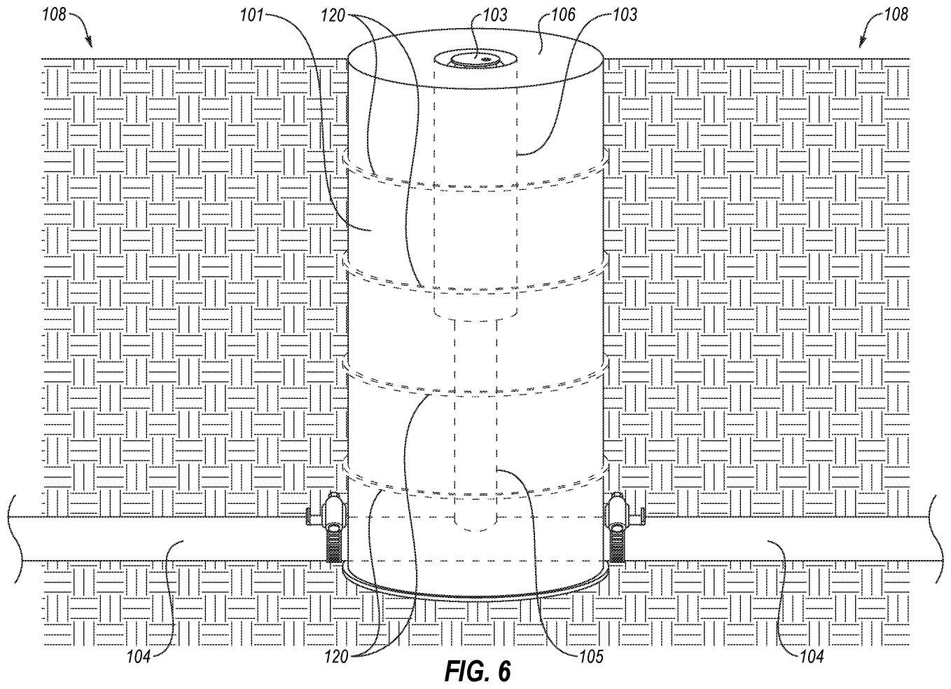

FIG. 1 is a perspective view of a sprinkler protector 101, in accordance with various embodiments of the present disclosure. As illustrated, sprinkler protector 101 includes a housing 102. Housing 102 is configured to receive a sprinkler head 103 (and possibly a riser 105; see FIG. 6), which is coupled to a sprinkler pipe 104. According to various embodiments, housing 102 may be positioned at least partially in the ground (i.e., underground) (e.g., see FIG. 6).

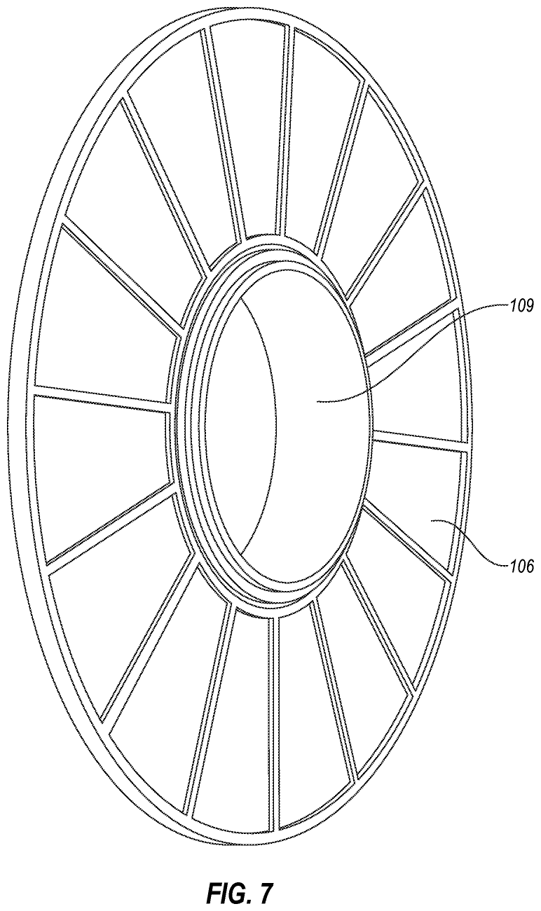

Sprinkler protector 101 further includes a removable lid 106 configured to couple at one end of housing 102. Lid 106 may include an opening 109 (see FIG. 7) for exposing at least a portion (e.g., a top portion) of sprinkler head 103. According to various embodiments, a size of the opening 109 in lid 106 may vary (e.g., depending on a type and/or size of a sprinkler head to be protected). In some embodiments, a size of opening 109 of lid 106 may be adjustable (e.g., via a number of collars (e.g., fit to lid 106)).

As illustrated in FIG. 1, in some embodiments, a portion of sprinkler head 103 may at least partially protrude from a top surface of lid 106. In other embodiments, a top surface of sprinkler head 103 may be substantially flush with a top surface of lid 106. Further, as will be appreciated, sprinkler head 103 in FIG. 1 is illustrated in a retracted position; however during operation, at least a portion of sprinkler head may “pop up” (e.g., above a ground surface) to disperse water.

It is noted that lid 106 and housing 102 may be sized such that, upon removal of lid 106, a sprinkler head (e.g., sprinkler head 103) may be accessed (e.g., to be repaired, removed, replaced, cleaned, etc.). More specifically, according to various embodiments, sprinkler head 103 and riser 105 may be easily accessed (e.g., removed and replaced) without digging and/or removing dirt and/or grass around sprinkler protector 101, as described more fully below.

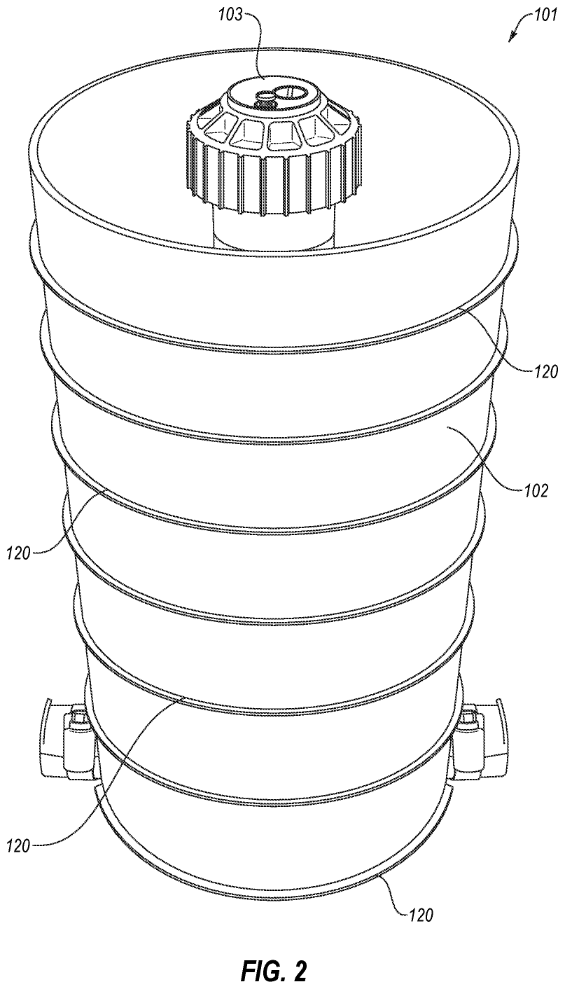

FIG. 2 is another perspective view of sprinkler protector 101 with lid 106 being removed. According to some embodiments, as illustrated in FIG. 2, an outer surface of housing 102 may include one or more rib-like structures (also referred to herein as “ribs”) 120. Ribs 120 may provide friction (e.g., with dirt surrounding housing 102). Ribs 120, which may be spaced any distance apart (e.g., every two inches), may be any suitable shape and/or size.

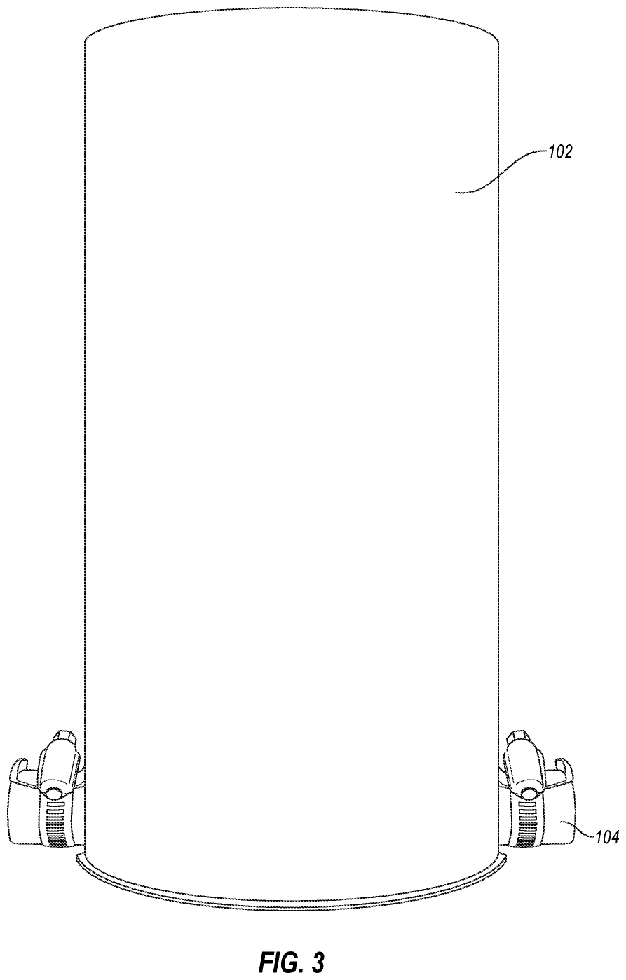

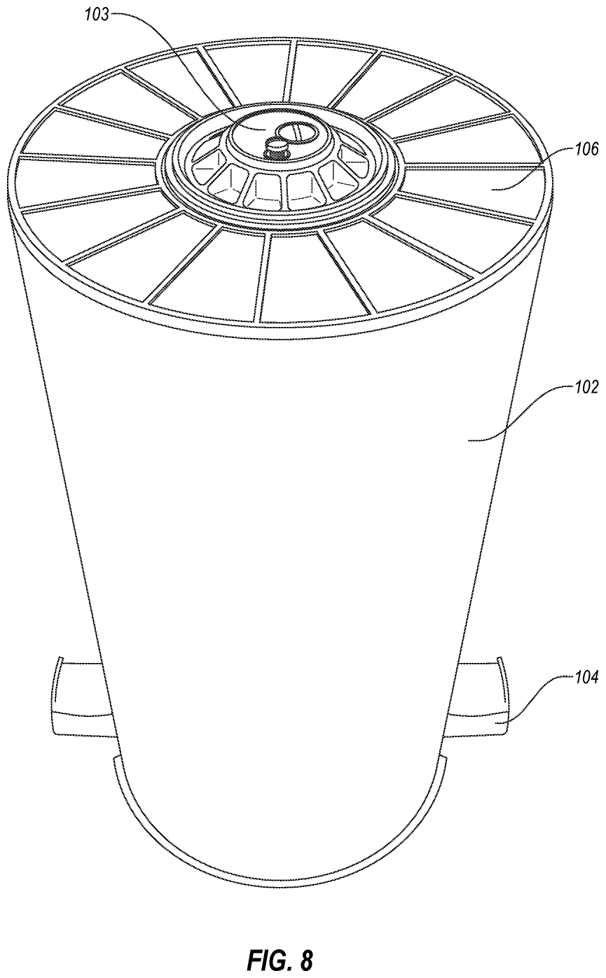

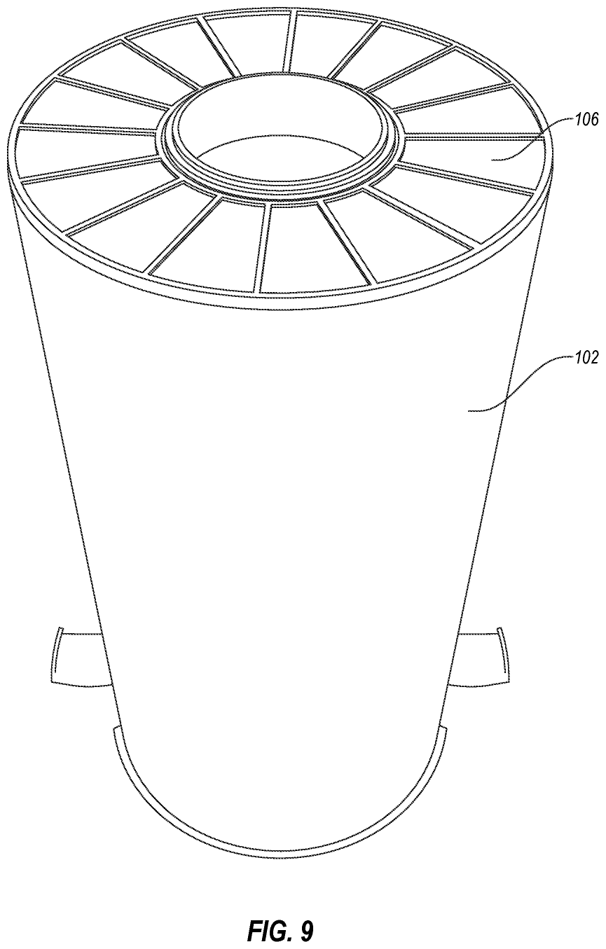

FIG. 3 is a side view of sprinkler protector 101. As shown in FIG. 3, housing 102 may be positioned adjacent (e.g., on) pipe 104. Although not necessary, in some embodiments, housing 102 may be attached (e.g., via one or more clamps) to pipe 104. In some embodiments, housing 102 may contact, and possibly rest on, pipe 104. Although various illustrations provided herein depict housing 102 attached to pipe 104 (i.e., via a number of clamps), the present disclosure is not so limited. Rather, according to some embodiments, housing 102 may be free standing and may not be attached to a pipe. More specifically, in at least some embodiments, housing 102 may not contact a pipe, and thus, if housing 102 is pushed down (e.g., via a car or a lawn mower), the pipe may not be damaged. For example, in these embodiments, housing 102 may be positioned adjacent a pipe of a sprinkler system. It is noted that the present disclosure is not limited to any specific configuration of housing 102 being positioned next to or in contact with a pipe. FIG. 8 depicts housing 102 positioned adjacent pipe 104 without clamps, and FIG. 9 depicts housing 102 without a pipe.

Further, in some embodiments, some portion of housing 102 may be thicker than another portion of housing 102. More specifically, for example, a top portion (top ⅕, top ¼, top ⅓, or other portion) of housing 102 may be thicker than another portion (e.g., a middle and/or bottom portion).

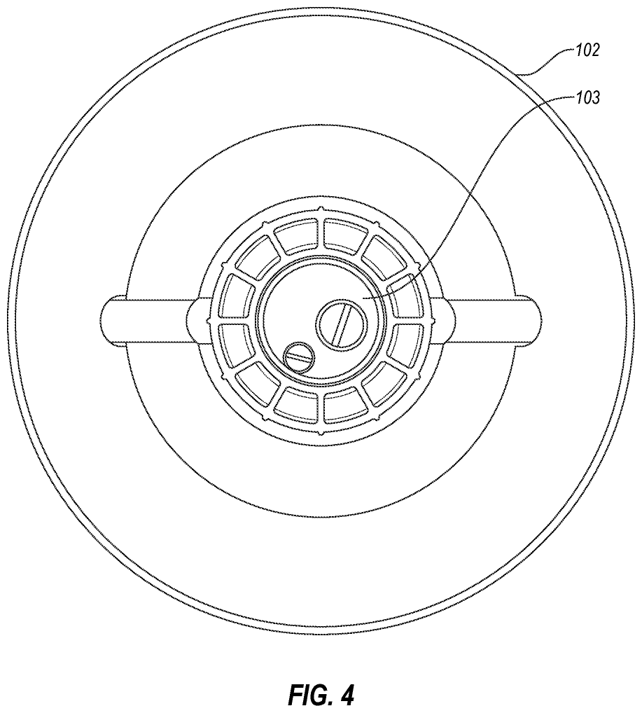

FIG. 4 is a top view of sprinkler protector 101 without lid 106, wherein sprinkler head 103 is at least partially surrounded by housing 102. With reference to at least FIGS. 2 and 4, a size of lid 106 and/or a size of housing 102 may be such that both sprinkler 103 and riser 105 are easily accessible. More specifically, housing 102 may be configured such that a user may access (e.g., repair and/or replace) sprinkler 103 and riser 105 without a need to dig either sprinkler 103 or riser 105 out of the ground. Rather, a user may simply remove lid 106, reach into housing 102, and detach (e.g., unscrew) sprinkler 103 and possibly riser 105.

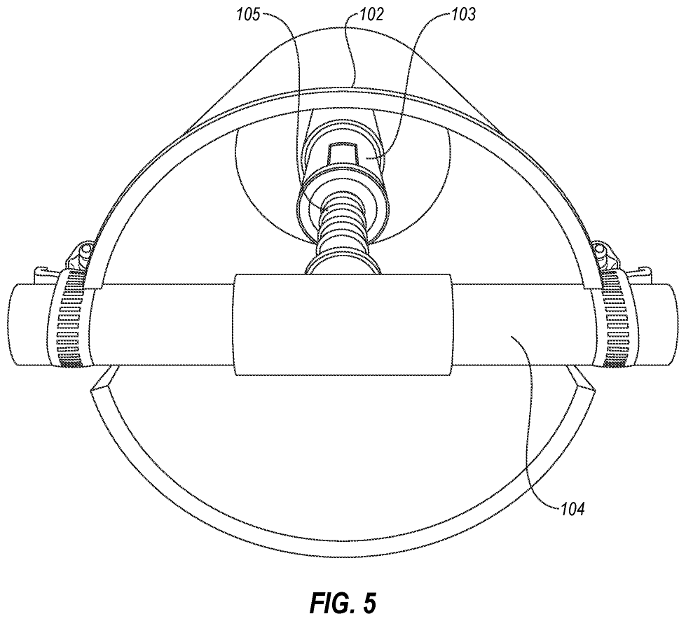

FIG. 5 is a bottom view of sprinkler protector 101. As shown in FIG. 5, riser 105, which is at least partially surrounded by housing 103, may couple to pipe 104.

FIG. 6 is a cut-out view of sprinkler protector 101 installed in ground surface 108. According to some embodiments, when installed in the ground, lid 106 may be substantially flush with ground surface 108. FIG. 7 depicts an opening 107 in lid 106.

In some embodiments, housing 102 may include a cylindrical housing, as shown in in FIGS. 1-6. However, housing 102 is not limited to a specific shape, and it will be appreciated that housing 102 may include any suitable shape (e.g., square shape, triangular shape, etc.). Further, it is noted that a shape and/or a size of housing 102 may depend on an installation position. More specifically, for example, if a sprinkler protector is to be positioned in or adjacent a corner area (e.g., of a lawn), housing may include a shape including, for example, a 90° corner (e.g., square shape or triangular shape).

Housing 102 and/or lid 106 may include any suitable material. For example, housing 102 and/or lid 106 may include metal, plastic (e.g., a hard plastic), a composite material, one or more other materials, or any combination thereof. Further, sprinkler protector 101 may be any suitable size. For example, a height of housing 102 may be approximately 12 inches, and a diameter of housing 102 may be approximately 6 inches. The dimensions are only provided as examples, and, as will be appreciated, other dimensions are within the scope of the present disclosure.

Further, according to various embodiments, sprinkler protector 101 may be modified to a desired size. More specifically, for example, a user (e.g., an installer) may modify housing 102 (e.g., cut housing 102) to decrease a height of housing 102. Moreover, for example, unlike some conventional devices, sprinkler protector 101 may be retro-fit to existing sprinkling systems (e.g., a size of housing 102, lid 106, and/or opening 109 in lid 106 may be modified) (e.g., by an installer).

Further, in contrast to some conventional devices that are physically connected to other components (e.g., sprinkler piping and/or a sprinkler head), sprinkler protector 101 may be simply positioned at least partially around a sprinkler head, and in some embodiments, sprinkler protector 101 may be simply rest on sprinkler piping (e.g., pipe 104). Moreover, unlike some conventional devices that have a point load on a sprinkler head, a riser, and/or a supply line, a point load of sprinkler housing 101 may be on housing 102. More specifically, according to at least some embodiments, ribs 120 (see FIG. 2) may cause a point load to be applied to housing 103, and not a sprinkler head, a riser, and/or a supply line. Thus, in comparison to conventional devices, sprinkler housing 101 may not damage an associated sprinkler head, a riser, and/or a supply line.

Other embodiments may include methods of manufacturing a sprinkler protector, methods of installing a sprinkler protector, and/or methods of using a sprinkler protector. Further, various embodiments may include system (e.g., a sprinkler and/or irrigation system) including one or more sprinkler protectors, as described herein.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. As used herein, “and/or” includes any and all combinations of one or more of the associated listed items.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternative useful combinations of the elements described, will become apparent to those skilled in the art from the description. Such modifications and embodiments also fall within the scope of the appended claims and equivalents.

What is claimed is:

1. A sprinkler protector, comprising:
a housing including a first end and a second, opposite end, the housing configured to receive a sprinkler head; and
a removable lid for coupling to the first end of the housing, the lid configured to enable for access to the sprinkler head upon the lid being removed, the lid including an opening to expose at least a portion of the sprinkler head while the lid is coupled to the first end of the housing;
wherein the second, opposite end includes an opening configured such that the sprinkler head may be coupled to a sprinkler pipe.

2. The sprinkler protector of claim 1, wherein the housing including one or more rib-like structures on a surface thereof.

3. The sprinkler protector of claim 1, wherein the opening of the lid is adjustable.

4. The sprinkler protector of claim 1, wherein the housing comprises at least one of plastic and metal.

5. The sprinkler protector of claim 1, wherein a surface of a first portion of the housing is thicker than a surface of another portion of the housing.
